(19) United States
(12) Patent Application Publication
(10) Pub. No.: US 2009/0000483 A1
(43) Pub. Date: Jan. 1, 2009

(54) INDUSTRIAL UNIT COMPRISING A DEVICE FOR PROTECTING THE INTERNAL PARTS THEREOF

(75) Inventors: Francois DE BUSSY, Paris (FR); Christian MONEREAU, Paris (FR); Jean-Claude BEAUVOIS, Soucy (FR)

Correspondence Address: AIR LIQUIDE;Intellectual Property, 2700 POST OAK BOULEVARD, SUITE 1800, HOUSTON, TX, 77056, US

(73) Assignee: L'Air Liquide, Societe Anonyme pour l'Etude et l'Exploitation des Procedes Georges Claude, Paris (FR)

(21) Appl. No.: 11/959,734

(22) Filed: Dec. 19, 2007

(30) Foreign Application Priority Data
Dec. 21, 2006 (FR) 0655772

(51) Int. Cl. B01D 53/02

(52) U.S. Cl. 96/153; 96/108

(57) ABSTRACT

An industrial unit (1) comprises internal parts (3, 4, 5) placed in a chamber (2, 8, 9) closed at least temporarily by a protective end (8, 9), the internal parts being connected to the atmosphere outside the chamber essentially via at least one line (6) allowing the passage of air from the exterior to the internal parts and from the internal parts to the exterior, the line containing at least one device (11) for trapping at least one undesirable atmospheric component.

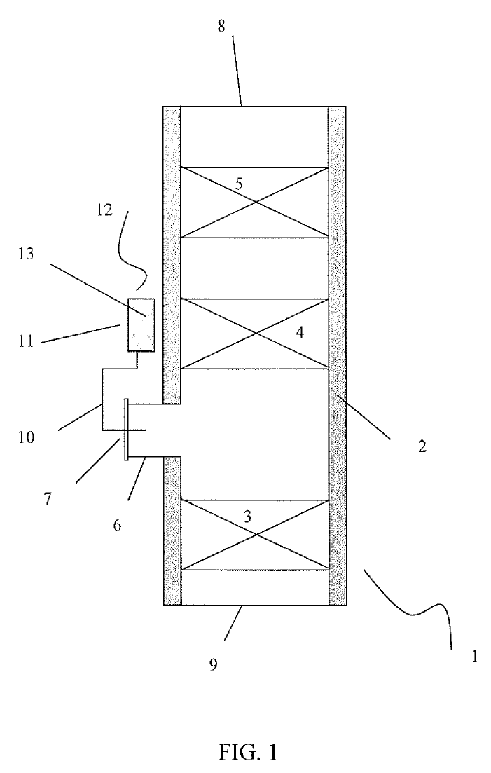

This application claims the benefit of priority under 35 U.S.C. § 119 (a) and (b) to French Application No. FR 0655772, filed Dec. 21, 2006, the entire contents of which are incorporated herein by reference.

The present invention relates to an industrial unit comprising a device for protecting the internal parts, particularly during construction, storage or transport periods.

The internal parts of industrial units, such as distillation column, tank, reactor, adsorber, are obviously suitable for the operating conditions of the unit in question, but may be vulnerable to prolonged contact with the surrounding atmosphere. The problems alluded to may be due to the usual components (moisture, carbon dioxide, oxygen, etc.) or to secondary pollutants, such as may be found in industrial areas (sulphur products, nitrogen oxides, etc.) or, for example, in a marine environment.

Mention can be made of the rusting of carbon steel in the presence of oxygen and moisture, the formation of hydrogen under the same conditions and in the presence of various impurities based on aluminium. It is also known that any trace of NH₃ must be avoided in the presence of copper, and that catalysts are poisoned by a large number of components liable to be found in a polluted or marine atmosphere (sulphur compounds, chlorine compounds, NOx, etc.).

There is therefore a real risk of pollution, corrosion, the creation of undesirable or even hazardous compounds, in case of the prolonged exposure to air of units such as distillation columns, particularly those comprising trays of aluminium or copper, reactors, tanks whose internal components are liable to oxidize. This risk is especially high during the fabrication, storage, transport, assembly, that is, when these units are not yet installed on their final site, connected to upstream and downstream units.

Solutions are available for overcoming these problems. Thus, fabrication can be carried out in a workshop with a controlled atmosphere and air filtration. During storage and transport, protection consists in sealing the inlets and outlets of the unit, for example by installing blind flanges on the piping.

For a section of a unit fabricated in pieces, for example, due to its very large size, it is routine practice to weld a temporary bottom to the free end. This is the case for certain distillation columns of which the final height is several tens of metres. This seal is then added to the more conventional plugging of the various inlet/outlet pipes of the unit, as described above. Since elliptical or hemispherical ends become very costly as their diameter increases, it is also customary to weld a simple disc, also temporarily, to safeguard the units during storage and transport. This solution, which is less expensive initially, is difficult to scale-up to large units.

The forces liable to be applied to the seal can in fact be calculated.

The forces applied to the end derive in fact from the differences in internal/external pressure. The pressure difference may originate in the climatic conditions via the direct effect of the atmospheric pressure, as well as variations in temperature. Variations of 20° C. can cause a pressure difference of about 80 mbar. The units stored in summer in a “cold” country could very substantially be under vacuum in winter. Such underpressures or overpressures cannot be withstood mechanically by simple thin sheet metal discs, on large-sized units. Incidentally, it is conventional practice to store and transport sections of distillation columns larger than 5 m in diameter.

During transport, differences in altitude along a route may cause similar effects. It may be accordingly excessively expensive to provide elliptical or even hemispherical ends having these diameters, or strongly reinforced flat ends (due to the limitations of the units themselves, the cost of manpower, the extra cost of transport due to the additional weight and/or dimensions).

The solution recommended here is effectively to seal a large-diameter cylindrical shell, for example using a thin sheet metal disc, and to conventionally plug the inlet/outlet pipes likely to be present on this unit, but to provide a deliberate link between the internal volume thus bounded and the atmosphere. In this way, potential gas transfers in one direction or the other serve at any time to balance the internal/external pressures. Since these exchanges take place via a clearly defined circuit, for example through a pipe, it is possible to place one or more traps on the said circuit, to capture all or at least most of the undesirable atmospheric components, due to the materials or products present inside the chamber.

In this way, the system is not sealed, but the air inflows (due to variations in temperature and pressure) are controlled by deliberately creating at least one leak on which a stripper is placed.

According to one object of the invention, an industrial unit is provided comprising internal parts placed in a chamber closed at least temporarily by a protective end, the internal parts being connected to the atmosphere outside the chamber essentially via at least one line allowing the passage of air from the exterior to the internal parts and from the internal parts to the exterior, the line containing at least one device for trapping at least one undesirable atmospheric component.

According to other objects of the invention, it is provided that:
the device(s) is/are suitable for trapping a component included in the following group: water, carbon dioxide, nitrogen oxides, acids, oxygen, alkalis, hydrocarbons;
the line is a pipe of the unit;
the line is a unit pipe serving for the passage of atmospheric air at ambient temperature during the construction, storage or transport periods, and connected to a fluid other than atmospheric air at ambient temperature in a period of operation of the unit;
the main axis of the device is vertical;
the device traps the component by chemical reaction and/or physically traps the component;
the device is an adsorbent such as zeolite, activated alumina, silica gel or active carbon optionally doped with additives;
the unit is a section of a distillation column, a chemical reactor, an adsorber or a tank.

It is thereby possible to use an adsorbent (active carbon or silica gel) chemically doped to stop the traces of chlorine products, HCl, etc. For other components present in larger quantities, the adsorption/desorption effect is used.

### BRIEF DESCRIPTION OF THE DRAWINGS

The invention may be understood by reference to the following description taken in conjunction with the accompanying drawing, and in which:

The sole FIGURE is a schematic of a distillation column representing an embodiment of the current invention.

It should be observed that the flows circulating through the trap will be alternating on the one hand, and locally small on the other.

The invention is described in greater detail with reference to the FIGURE, which shows a distillation column according to the invention.

A column section 1 to be protected from external attack comprises a cylindrical shell containing three modules of trays or structured packings 3, 4, 5. An inlet or outlet duct 6 penetrates through the shell between the modules 3 and 4. This duct is closed by a blind flange which seals it.

During the transport of the section, the two openings of the shell are closed by thin sheet metal discs which seal the section without necessarily adding mechanical strength.

A circuit 10 causes the internal atmosphere of the section 1 to communicate with the external atmosphere via a stripper 11.

The stripper 11 comprises an opening 12 for gas exchanges with the atmosphere and contains a material 13 for trapping the atmospheric impurities.

The operation of the assembly is now illustrated by taking an example—non-limiting—relative to the retention of the atmospheric moisture during a period of storage of a column section, the incoming and outgoing streams being directly associated with the variations in day and night temperature.

Assuming a column section has a diameter of 4 m and a length of 8 m, the internal volume tightly isolated from the exterior (except through the pressure balancing pipe) is about 100 m³. Assuming a temperature difference between night and day of 20° C., the quantities of air entering and then leaving the volume amount to about 7 to 8 Nm³.

Assuming a mean relative humidity of about 60 or 70%, the quantity of water vapour that may enter the unit in each cycle is about a hundred grams. This quantity is sufficiently large to ultimately cause corrosion, poison the catalysts and maintain undesirable chemical reactions, but on the other hand it is sufficiently small to be stopped, even completely, on an adsorbent of the alumina or silica gel type. A few kilograms of adsorbents can retain this quantity of water without any problem and dry the gas entering the unit.

The advantageous factor is that the wet gas passes on the adsorbent when the temperature cools, which is favourable to adsorption, that is, in the case of retention of the water. Conversely, the dry gas flows from the unit to the external environment as the temperature warms, which is favourable to desorption, that is, regeneration of the adsorbent.

In particular, if the trap containing the adsorbent is installed outside the unit, the temperature of the adsorbent rapidly matches the variations in external temperature, warming more rapidly than the internal part of the unit, the heat capacity of which is higher. This means that at the end each daily cycle, the adsorbent is definitely regenerated because it has witnessed the regeneration of the same quantity of gas as in adsorption at a higher temperature. The few kilograms of adsorbent mentioned above are therefore sufficient, regardless of the storage or transport time.

It is also found that the pressure effects (variation in barometric pressure, variable altitude) favour the regeneration of the adsorbent: the wet air enters when the pressure rises and leaves when the pressure falls; to some extent, this is the very principle of PSA processes.

It is possible to install, in series, a plurality of beds of various adsorbents according to the compounds to be retained. It is feasible to install a few kilograms of activated alumina, and a few hundred grams of barium exchange sieve or specific zeolite, or doped carbon, to stop, in addition to the atmospheric moisture, for example, traces of HCl (chemical trapping on alumina), NH₃, hydrocarbons, etc.

The adsorbents may be placed in a 10 cm diameter pipe section, for example, maintained between two grids or in boxes or housings of various shapes.

Preferably, the main axis of the trap should be vertical, so that the air flows through the adsorbents without a line to short-circuit the trap. If two positions are provided for the unit, for example upright for storage and horizontal for transport, the shape of the trap should be adapted to be effective in both positions, or two fastening positions should be provided at the design stage.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

What is claimed is:

1. Industrial unit comprising internal parts placed in a chamber closed at least temporarily by a protective end, the internal parts being connected to the atmosphere outside the chamber essentially via a single line allowing the passage of air from the exterior to the internal parts and from the internal parts to the exterior, the line containing at least one device for trapping at least one undesirable atmospheric component.

2. The unit of claim 9, in which the device(s) is/are suitable for trapping a component included in the following group: water, carbon dioxide, nitrogen oxides, acids, oxygen, alkalis, hydrocarbons.

3. The unit of claim 9, in which the line is a pipe of the unit.

4. The unit of claim 11, in which the line is a unit pipe serving for the passage of atmospheric air at ambient temperature during the construction, storage or transport periods, and connected to a fluid other than atmospheric air at ambient temperature in a period of operation of the unit.

5. The unit of claim 11, in which the main axis of the device is vertical.

6. The unit of claim 9, in which the device traps the component by chemical reaction and/or physically traps the component.

7. The unit of claim 9, in which the device contains an adsorbent such as zeolite, activated alumina, silica gel or active carbon optionally doped with additives.

8. The unit of claim 9, being a section of a distillation column, a chemical reactor, an adsorber, or a tank.
